(19) United States
(12) Patent Application Publication
(10) Pub. No.: US 2022/0192117 A1
(43) Pub. Date: Jun. 23, 2022

(54) HYDROPONIC PLANT CULTIVATING SYSTEM

(71) Applicant: Eric Zavo, Brewster, MA (US)

(72) Inventor: Eric Zavo, Brewster, MA (US)

(21) Appl. No.: 17/412,449

(22) Filed: Aug. 26, 2021

Related U.S. Application Data
(60) Provisional application No. 63/126,805, filed on Dec. 17, 2020.

(51) Int. Cl. A01G 31/06

(52) U.S. Cl. CPC A01G 31/06; A01G 2031/006

(57) ABSTRACT

The present invention relates to a hydroponic plant growing system. The hydroponic plant growing system includes a reservoir for storing a watering solution including water along with nutrients, a planting lid releasably-engaged to the reservoir, a transparent lid disposed to cover the planting lid and a bubbler or an air pump connected to an air stone for producing bubbles in the watering solution. The planting lid includes a plurality of embedded cups for retaining the plants and enabling the plants to receive nutrients from the watering solution therebelow. A solar panel provides power to the bubbler. The plants are suspended over the bubbled watering solution and nutrients, thereby enabling plants to be grown both indoors and outdoors.

### CROSS-REFERENCE TO RELATED APPLICATION

The present application claims priority to, and the benefit of, U.S. Provisional Application No. 63/126,805, which was filed on Dec. 17, 2020 and is incorporated herein by reference in its entirety.

### FIELD OF THE INVENTION

The present invention relates generally to a hydroponic system for plant cultivation. More specifically, the present invention relates to a hydroponic plant cultivation system that facilitates optimal plant growth both indoors and outdoors. The system includes a large cooler or reservoir body, several solar panels that power a bubbler and a planting lid. The planting lid includes several rubber stability grommets and multiple embedded cups to house plant seeds. The bubbler pumps the nutrients and water stored in the large cooler body into the embedded cups for providing adequate nutrition. A plurality of solar panels provide power to the bubbler for providing continuous nutrition to the plants and plant seeds. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, individuals typically grow plants in a standard garden in an outdoor environment using traditional growing methods. These traditional growing methods generally require large areas of space with plenty of sun and water. Also, this cultivation method requires extensive maintenance, gallons of water and rich and optimal soil. Individuals who are fond of cultivation and gardening may not have enough space and/or resources to pursue their passion and desire of cultivation.

Also, apartment dwellers and homeowners may have considerable issues when trying to grow plants due to lack of space and lack of availability of soil and other nutrients. Such indoor gardening also requires soils of different types based on the type of plant being grown. Further, extensive maintenance and frequent watering can present difficult and annoying tasks.

As a result, there has been a renewed interest in soilless growing techniques that do not require the use of pesticides, drastically reduce the use of water and allow for growing varietals that are bred for nutrition and flavor instead of durability. Hydroponics is defined as a method and a system of growing plants without the use of soil. Hydroponic systems are designed to deliver a nutrient solution to the plants at a controlled rate. The delivery of the nutrient solution to the plants at a controlled rate causes an accelerated plant growth within the limited spaces such as an indoor environment. However, current hydroponics systems are expensive to manufacture, difficult to maintain and difficult to use. Heretofore systems may require professional help for setting up and use. Further, current hydroponics may not efficiently provide nutrients to the plants, and are inefficient for indoor purposes. Also, current hydroponic systems require additional oxygen which can be difficult to provide for individuals.

Therefore, there exists a long felt need in the art for a hydroponic system that grows soilless plants at an optimal level, with minimal maintenance in both indoor and outdoor environments. There is also a long felt need in the art for a hydroponic system that requires minimal space and obviates frequent watering. Additionally, there is a long felt need in the art for a hydroponic system that is easy and cost-effective to manufacture and use. Further, there is a long felt need in the art for a hydroponic system that does not require additional oxygen to the nutrients. Moreover, there is a long felt need in the art for a hydroponic system that can be used by novice users, and does not require professional help to set up. Finally, there is a long felt need in the art for a hydroponic system that facilitates cost-effective and optimal soilless plant growth using a nutritive solution in both indoor and outdoor environments.

The subject matter disclosed and claimed herein, in one embodiment thereof, comprises a hydroponic plant growing system. The hydroponic plant growing system is designed to grow plants in both indoor and outdoor environments. More specifically, the system includes a large cooler for storing water and nutrients for feeding a plurality of plants or plant seeds. A planting lid can be placed on an upper opening of the cooler, and includes a plurality of rubber stability grommets with embedded insulated cups for housing plants or plant seeds. A water bubbler is used for producing bubbles in stored water for delivering oxygen and nutrients to the plurality of plants and a plurality of solar panels can be used for providing power to the bubbler. The plants are suspended over the water and nutrients stored in the cooler, thereby enabling plants to be grown by pumping water and nutrients from the cooler to the insulated cups.

In this manner, the hydroponic system of the present invention accomplishes all of the forgoing objectives, and provides a relatively cost-effective, easy and convenient system to allow both novice and professional users to grow plants of various types without soil in both indoor and outdoor environments. The hydroponic system provides nutrients to the plants by pumping nutrition to the plants from a nutritive solution stored in a reservoir using a bubbler. The system can be self-powered using solar panels and obviates the need for additional oxygen.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hydroponic plant cultivation system. The hydroponic plant cultivation system is configured to grow plants at an optimal level with minimal maintenance both indoors and outdoors. More specifically, the system further comprises a large cooler acting as a reservoir of water and nutrients for feeding a plurality of plants or plant seeds, a planting lid placed on an upper opening of the cooler and having a plurality of rubber stability grommets with embedded insulated cups wherein each embedded cup houses plants or plant seeds, a water bubbler for producing bubbles in stored water for delivering oxygen and nutrients to the plurality of plants, a plurality of solar panels for providing power to the bubbler and a transparent lid allowing a user to see the growth of the plants. The plants can be suspended over the water and nutrients stored in the cooler, thereby enabling plants to be grown by pumping water and nutrients from the cooler to the insulated cups.

In yet another embodiment of the present invention, the hydroponic plant growing system can be set up in an outdoor environment or an indoor environment and requires less space than conventional hydroponic systems.

In yet another embodiment of the present invention, the bubbler can be in the form of an air stone connected to an air pump, and provides continuous flow of the nutrient solution to the plants or plant seeds placed in the insulated cups. In yet another embodiment of the present invention, the planting lid is releasably-engaged to the opening of the cooler and the cooler can be in the form of a cylindrical bucket.

In a further embodiment of the present invention, a method for growing plants without use of soil is described. The method includes initially storing water and nutrients in a cooler body, coupling stored water with a bubbler for producing bubbles in the stored water, powering the bubbler with one or more solar panels, planting saplings or seeds in insulated cups embedded within rubber stability grommets in a planting lid, such that the plants are suspended over the stored water, and pumping the water and the nutrients from the cooler body into the insulated cups using the bubbler for facilitating plant growth without using soil.

In yet another embodiment of the present invention, the method can be used for hydroponic flowers, herbs, and vegetables and the cooler or reservoir can be supplied with nutrient-rich solutions, oxygen and water.

In yet another embodiment of the present invention, a hydroponic system is disclosed. The hydroponic system includes a plant-holding panel having a plurality of insulated cups in which plant seeds or plants are placed, a cooler storing water and nutrients over which the plants are suspended, a bubbler for forming bubbles in stored water, a plurality of solar panels for providing power to the bubbler and a transparent lid for providing insulation and viewing of the growing plants.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a hydroponic plant cultivation system of the present invention in accordance with the disclosed architecture;

FIG. 2 illustrates a perspective view showing another embodiment of a hydroponic plant cultivation system of the present invention in accordance with the disclosed architecture;

FIG. 3 illustrates a perspective view of one potential embodiment showing a planting lid along with solar panel and air stone used in the hydroponic system of the present invention in accordance with the disclosed architecture;

FIG. 4 illustrates a perspective view showing growth of a plant within an insulated cup disposed within the planting lid used in the hydroponic system of the present invention in accordance with the disclosed architecture;

FIG. 5 illustrates a block diagram showing components of a bubbler used in the hydroponic system of the present invention in accordance with the disclosed architecture; and

FIG. 6 illustrates an exemplary flow diagram illustrating a method for operating the hydroponic system according to one potential embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there a long felt need in the art for a hydroponic system that grows soilless plants at an optimal level with minimal maintenance in both indoor and outdoor environments. There is also a long felt need in the art for a hydroponic system that requires a small amount of space and obviates frequent watering. Additionally, there is a long felt need in the art for a hydroponic system that is easy and cost-effective to manufacture and use. Further, there is a long felt need in the art for a hydroponic system that does not require additional oxygen to the nutrients. Moreover, there is a long felt need in the art for a hydroponic system that can be used by novice users, and does not require professional help to set up. Finally, there is a long felt need in the art for a hydroponic system that facilitates cost-effective and optimal soilless plant growth, using a nutritive solution in both indoor and outdoor environments.

The present invention, in one exemplary embodiment, includes a hydroponic plant growing system. The hydroponic plant growing system includes a plant holding panel having a plurality of insulated cups in which plant seeds or plants are placed, a cooler or reservoir storing water and nutrients over which the plants are suspended, a bubbler for forming bubbles in stored water, a plurality of solar panels for providing power to the bubbler and a transparent lid for providing insulation and viewing of the growing plants.

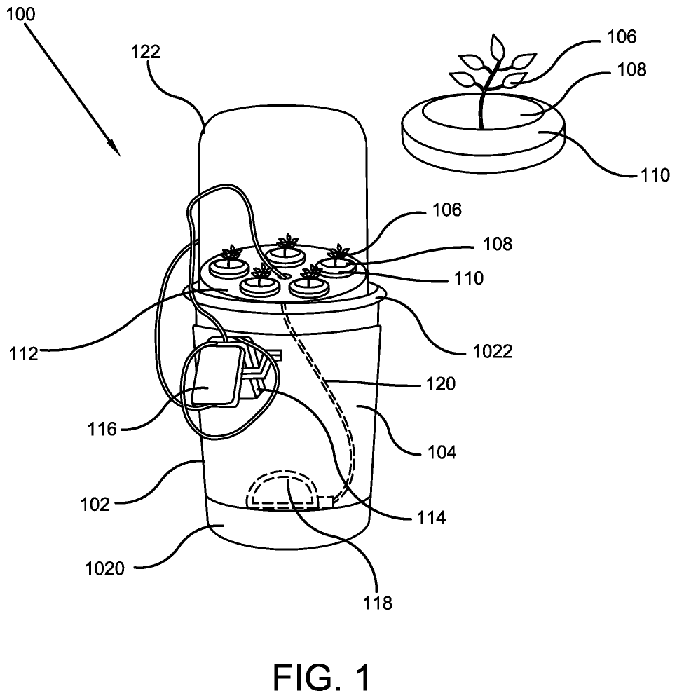

Referring initially to the drawings, FIG. 1 illustrates a perspective view of a hydroponic plant cultivation system of the present invention in accordance with the disclosed architecture. The hydroponic plant cultivation system 100 is designed to grow soil-less plants at an optimal level, with minimal maintenance in both indoor and outdoor environments. The hydroponic plant cultivation system 100 includes a cooler or reservoir 102 used as a reservoir for retaining a watering solution 104, and includes a closed bottom end 1020 and an open top end 1022. The reservoir 102, as shown, is cylindrical or tapered in shape, however the reservoir 102 can be of any geometric shape. The cooler 102 can be filled with a watering solution 104 having nutrients that are administered to plants 106 located in the plurality of insulated cups 108. The watering solution 104 can be any solution, including but not limited to: mineral nutrients, aerated water and compost tea. The watering solution 104 is replaceable and can comprise any suitable watering solution 104 as per the needs of the plants 106.

A plurality of insulated cups 108 for storing plants 106 are disposed on a planting lid 112 secured to the open top end 1022 of the cooler 102 wherein the planting lid 112 is releasably-engaged to the top end 1022. Each insulated cup 108 can be secured therearound by a rubber grommet 110 for providing security and insulation to the plant 106. The growth of plants 106 may be started using, for example, plant seeds or cuttings. The seeds or cuttings may be placed within the insulated cups 108. Utilization of the insulated cups 108 results in the plant's root system being suspended within the cooler 102 for receiving nutrients from the watering solution 104 therebelow.

For providing nutrition through the watering solution 104 from the reservoir 102 to the plants 106, a bubbler or an air pump 114 powered by an integrated solar panel 116 can be used for agitating, aerating and creating bubbles in the watering solution 104. The bubbler 114 can be connected to an air stone 118 through a conduit 120 for creating bubbles in the watering solution 104. The conduit 120 passes through the planting lid 112 (or another location, such as the side, etc.) to connect the air stone 118 and the bubbler 114. Bubbling of the watering solution 104 is advantageous for the present invention, as without bubble action in the watering solution 104, the watering solution 104 can stagnate and brew undesirable bacteria called anaerobes. Also, bubbles of air released into the nutrient solution 104 by the combination of the bubbler 114 and the air stone 118 turn the reservoir 102 into an aeroponic zone, with high humidity and nutrients delivered to the plant's roots. Also, bubble action prohibits the build-up of humidity in the reservoir 102 between the watering solution 104 and the planting lid 112, thus preventing moisture from forming mold inside the reservoir 102.

The solar panel 116 includes a plurality of photovoltaic cells for converting solar energy into electrical energy for providing power to the bubbler 114 and the air stone 118 for forming bubbles in the watering solution 104. The solar panel 116 can be selectively attached to the bubbler 114 and can be detached for solar recharging in case the hydroponic system 100 is used in an indoor environment.

It should be appreciated that the plants 106 within the insulated cups 108 are suspended over the watering solution 104, thereby resulting in the roots of the plants 106 receiving nutrients and enabling plants to be grown both indoors and outdoors. For providing adequate temperature for the plants 106 to grow, the hydroponic system 100 includes a transparent lid 122 for covering the plants 106. The transparent lid 122 secures over the planting lid 112 and a user can also view growth of the plants 106 through the transparent lid 122.

The hydroponic plant growing system 100 is a self-contained hydroponic plant growing system for both indoor and outdoor locations. While the system 100 may be utilized for growing small herbs or flowers, it can also be used for growing vegetables. The system 100 can extend to a height of approximately five feet tall or more, and can accommodate between five and ten plants. This hydroponic plant growing system 100 does not use soil or any other energy source, and is ideal for use in buildings and apartments. The hydroponic plant growing system 100 is durable and stable, and does not fall easily when there is constant tending and working with plants 106 retained therein. Preferably, the system 100 breaks down into distinct components: the transparent lid 122, the planting lid 112, the cooler 102, and the combination of bubbler 114, solar panel 116 and air stone 118, for the purpose of shipping the hydroponic plant growing system 100. The cooler 102 and the planting lid 112 can be fabricated from one or more materials selected from the group, consisting of polyethylene, polypropylene, polyvinyl chloride, polytetrafluoroethylene, wood, bamboo and acrylonitrile butadiene styrene.

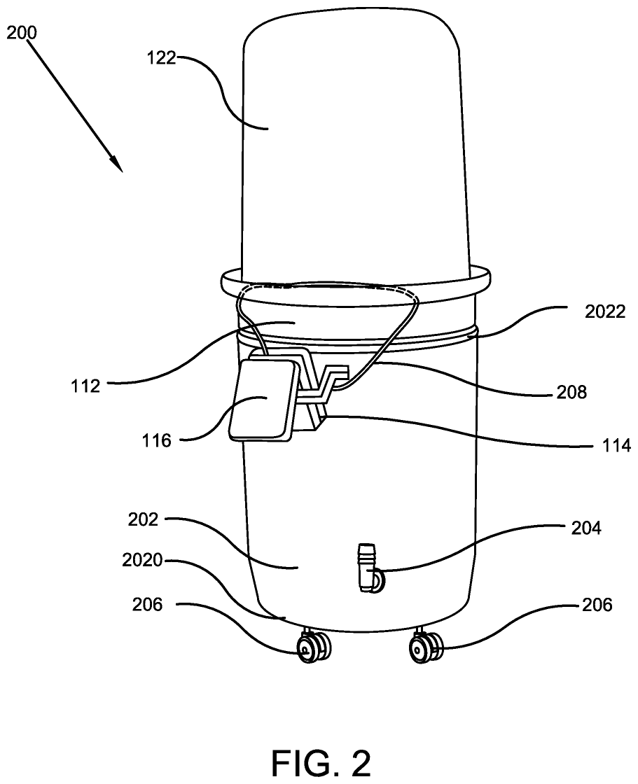

FIG. 2 illustrates a perspective view showing another embodiment of the hydroponic plant cultivation system of the present invention in accordance with the disclosed architecture. In the present embodiment, a movable or portable hydroponic system 200 includes a modified cooler body 202 for storing water and nutrients. The cooler body 202 includes an inlet 204 through which the watering solution can be supplied. The inlet 204 can be opened like a tap when the watering solution is to be added into the cooler 202, and then can be closed, thereby prohibiting leaking of the watering solution. The cooler body 202 includes selectively-detachable casters 206 at the bottom end 2020, thereby enabling the hydroponic system 200 to easily move by rolling the casters 206. The movable hydroponic system 200 is easy to move, even when the watering solution is present in the cooler 202. Additionally, in some embodiments, casters 206 can be equipped with one or more stoppers or adjustable locks, which can be actuated to prevent the casters 206 from moving unintentionally.

The planting lid 112, having a plurality of cups for plants, is engaged to the top end 2022 of the cooler body 202 and is covered by the transparent lid 122. For securing the bubbler 114 and the solar panel 116 to the cooler body 202, a strap 208 can be used for hanging both the bubbler 114 and the solar panel 116 for easy accessibility.

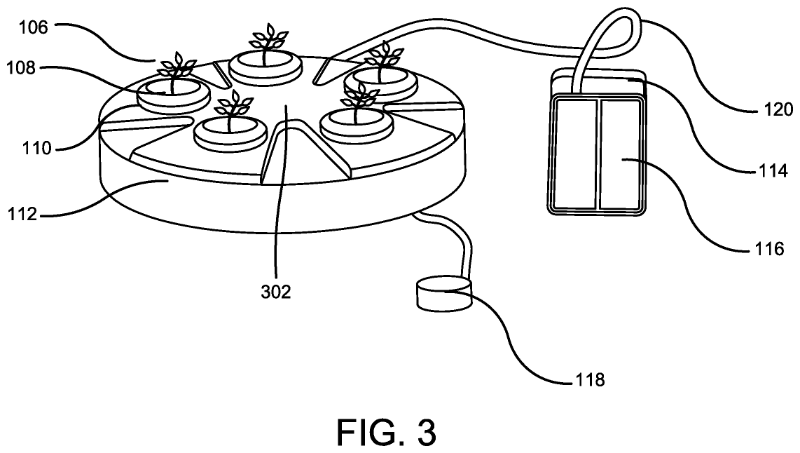

FIG. 3 illustrates a perspective view showing a planting lid along with a solar panel and an air stone used in the hydroponic system of the present invention in accordance with the disclosed architecture. The planting lid 112 can be generally circular in shape and conforming to the diameter of the cooler body. The planting lid 112 includes a plurality of rubber stability grommets 110 surrounding or circumscribing the embedded cups 108. The embedded cups 108 are used for storing the plants 106 or plant seeds. The embedded cups 108 can be in the form of pod inserts. The roots of the plants 106 can receive nutrients from the watering solution of the cooler body. For providing nutrients effectively to the plants 106 through their roots, the air stone 118 can be connected through a conduit 120 to the bubbler 114. The bubbler 114, along with the air stone 118, produces bubbles in the watering solution and creates an aerated nutrient solution for the plants 106. The solar panel 116, including photovoltaic cells, provides power to the bubbler 114 and the air stone 118 for providing bubbles in the watering solution. The conduit 120 passes through a central hole 302 of the planting lid 112, thereby allowing a proper attachment means for the conduit 120.

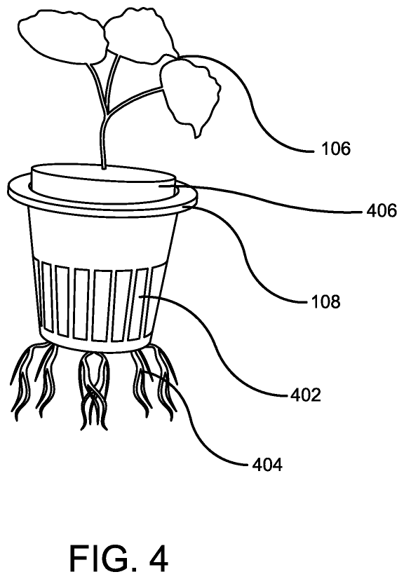

FIG. 4 illustrates a perspective view showing growth of a plant within an insulated cup disposed within the planting lid used in the hydroponic system of the present invention in accordance with the disclosed architecture. The insulated or embedded cup 108 includes draining spaces 402 for allowing the roots 404 of the plant 106 to grow. While the roots 404 grow, they receive nutrients from the bubbled watering solution. The plant 106 is a soilless plant wherein a base of the plant and/or the roots 404 can be surrounded by a plant-growing medium 406, selected from the group consisting of one or more of a coconut coir, a lightweight expanded clay aggregate (LECA) or a rock wool. As the roots 404 receive nutrients, the plant 106 grows in a convenient manner in both indoor and outdoor environments.

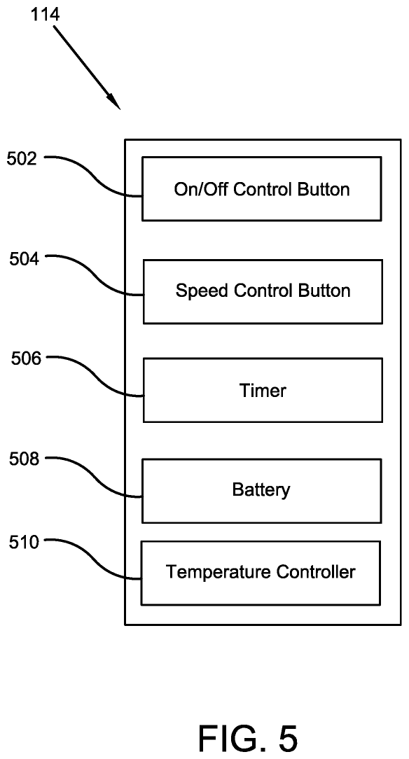

FIG. 5 illustrates a block diagram showing components of the bubbler 114 used in the hydroponic system of the present invention in accordance with the disclosed architecture. The bubbler 114 provides control buttons for allowing a user to control operation of the bubbling actions in the watering solution stored in the cooler body. An On/Off control button 502 allows the bubbler 114 to be turned on and off as per the preferences of the user. For controlling the number of bubbles to be formed within the watering solution, a speed control button 504 can be activated. The speed of agitation by the bubbler 114 can be controlled or modified using the speed control button 504. For allowing the bubbles to form periodically, a periodic timer value can be set using a timer control button 506 to initiate timed durations of actuating the bubbler 114. This helps the user to periodically and autonomously provide nutrients to the plants.

The bubbler 114 includes a built-in battery 508 that stores the electrical energy provided by the solar panel after converting from received solar energy. The built-in battery 508 can be a Li-Ion battery, and can provide power for the bubbler 114. The bubbler 114 can further include a temperature controller 510. The temperature controller 510 enables the temperature of the watering solution to be controlled and enables the adjustment of oxygenation levels.

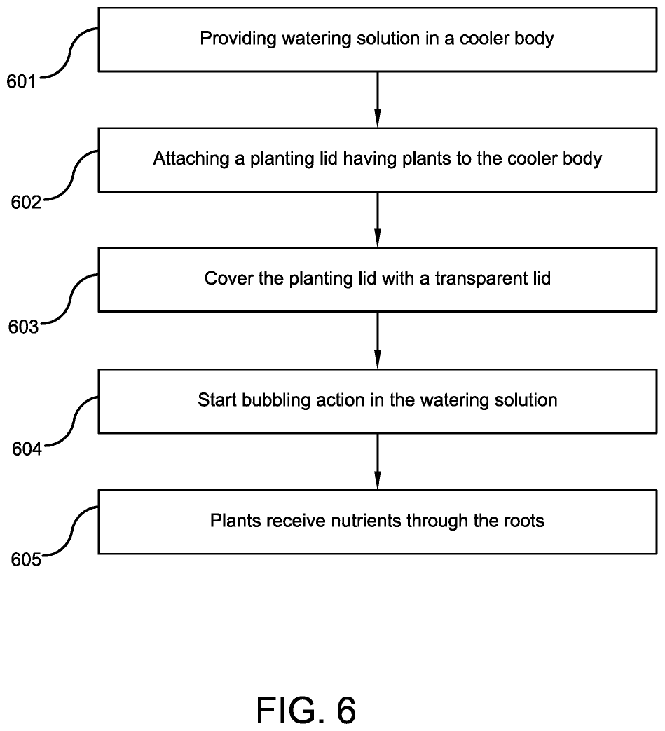

FIG. 6 illustrates an exemplary flow diagram illustrating a method for operating the hydroponic system according to an embodiment of the present invention. Initially in step 601, a watering solution having nutrients and compost is provided in a cooler or reservoir. In step 602, a planting lid having plants in embedded cups is releasably engaged to the cooler body. Then, in step 603, the engaged planting lid is covered with a transparent lid for providing additional insulation and temperature control. In step 604, bubbling action in the watering solution is started using an air pump and an air stone. This enables the nutrients and other minerals to agitate and reach the top of the watering solution. In step 605, plants suspended over the watering solution receive nutrients through their roots.

Typically, one hole, netcup or grommet in the center of the cooler would be used for bigger plants, and approximately six holes could be drilled out to accommodate smaller plants. Additionally, the bubblers may be solar for outdoor use, and can be plugged in by way of a USB to micro USB for indoor use.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hydroponic plant cultivation system”, “hydroponic plant growing system”, “hydroponic system”, “system”, and “movable hydroponic system” are interchangeable and refer to the hydroponic plant cultivation system 100, 200 of the present invention.

Notwithstanding the forgoing, the hydroponic plant cultivation system 100, 200 of the present invention can be of any suitable size and configuration as is known in the art without affecting the overall concept of the invention, provided that it accomplishes the above-stated objectives. One of ordinary skill in the art will appreciate that the size, configuration, and material of the hydroponic plant cultivation system 100, 200 as shown in the FIGS. are for illustrative purposes only, and that many other sizes and shapes of the hydroponic plant cultivation system 100, 200 are well within the scope of the present disclosure. Although the dimensions of the hydroponic plant cultivation system 100, 200 are important design parameters for user convenience, the hydroponic plant cultivation system 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hydroponic plant cultivating system comprising:
a reservoir for retaining a combination of water and nutrients for feeding a plurality of plants thereabove;
a planting lid positioned on an upper opening of said reservoir, wherein said planting lid includes a plurality of insulated cups for housing said plurality of plants;
a water bubbler for producing oxygenated bubbles in said water and said nutrients for delivering oxygen and aerated said nutrients to said plurality of plants; and
a transparent lid extending over said planting lid and around said reservoir.

2. The hydroponic plant cultivating system of claim 1, wherein said plurality of plants are plant seeds.

3. The hydroponic plant cultivating system of claim 1, wherein each said plurality of insulated cups include a grommet circumscribing an opening around each said plurality of insulated cups.

4. The hydroponic plant cultivating system of claim 1 further comprising a speed controller for modifying a speed of agitation of said bubbler.

5. The hydroponic plant cultivating system of claim 4 further comprising a timer for setting periodic time durations of actuating said bubbler.

6. The hydroponic plant cultivating system of claim 1 further comprising an air stone in said reservoir for creating an aerated nutrient solution for the plants.

7. The hydroponic plant cultivating system of claim 1 further comprising a solar panel mounted to said reservoir for powering a battery, wherein said battery supplies power to said bubbler.

8. The hydroponic plant cultivating system of claim 1, wherein said reservoir comprises one or more materials selected from the group consisting of a polyethylene, a polypropylene, a polyvinyl chloride, a polytetrafluoroethylene, a wood, a bamboo, and an acrylonitrile butadiene styrene.

9. The hydroponic plant cultivating system of claim 1 further comprising a plant growing medium surrounding a base of said plant, wherein said medium is selected from the group consisting of a coconut coir, a lightweight expanded clay aggregate, and a rock wool.

10. The hydroponic plant cultivating system of claim 1 further comprising a temperature controller for adjusting a temperature of said water and said nutrients.

11. A hydroponic plant cultivating system comprising:
a reservoir for retaining a combination of water and nutrients for feeding a plurality of plants thereabove;
a planting lid positioned on an upper opening of said reservoir, wherein said planting lid includes a plurality of insulated cups for housing said plurality of plants;
a water bubbler for producing oxygenated bubbles in said water and said nutrients for delivering oxygen and aerated said nutrients to said plurality of plants;
a transparent lid extending over said planting lid and around said reservoir;
a speed controller for modifying a speed of agitation of said bubbler;
a timer for setting periodic time durations of actuating said bubbler; and
an air stone in said reservoir for creating an aerated nutrient solution for the plants.

12. The hydroponic plant cultivating system of claim 11, wherein said plurality of plants are plant seeds.

13. The hydroponic plant cultivating system of claim 11, wherein each said plurality of insulated cups include a grommet circumscribing an opening around each said plurality of insulated cups.

14. The hydroponic plant cultivating system of claim 11 further comprising a solar panel mounted to said reservoir for powering a battery, wherein said battery supplies power to said bubbler.

15. The hydroponic plant cultivating system of claim 11, wherein said reservoir comprises one or more materials selected from the group consisting of a polyethylene, a polypropylene, a polyvinyl chloride, a polytetrafluoroethylene, a wood, a bamboo, and an acrylonitrile butadiene styrene.

16. The hydroponic plant cultivating system of claim 11 further comprising a plant growing medium surrounding a base of said plant, wherein said medium is selected from the group consisting of a coconut coir, a lightweight expanded clay aggregate, and a rock wool.

17. The hydroponic plant cultivating system of claim 11 further comprising a temperature controller for adjusting a temperature of said water and said nutrients.

18. A hydroponic plant cultivating system comprising:
a reservoir for retaining a combination of water and nutrients for feeding a plurality of plants thereabove;
a planting lid positioned on an upper opening of said reservoir, wherein said planting lid includes a plurality of insulated cups for housing said plurality of plants;
a water bubbler for producing oxygenated bubbles in said water and said nutrients for delivering oxygen and aerated said nutrients to said plurality of plants;
a transparent lid extending over said planting lid and around said reservoir;
a speed controller for modifying a speed of agitation of said bubbler;
a timer for setting periodic time durations of actuating said bubbler; and
a temperature controller for adjusting a temperature of said water and said nutrients.

19. The hydroponic plant cultivating system of claim 18 further comprising a solar panel mounted to said reservoir for powering a battery, wherein said battery supplies power to said bubbler.

20. The hydroponic plant cultivating system of claim 18, wherein said plurality of insulated cups further comprise a plant growing medium, and further wherein said plant growing medium is selected from the group consisting of a coconut coir, a lightweight expanded clay aggregate, and a rock wool.
